(19) United States
(12) Patent Application Publication
(10) Pub. No.: US 2018/0027049 A1
(43) Pub. Date: Jan. 25, 2018

(54) COMPUTING SYSTEM AND METHOD OF OPERATING THE COMPUTER SYSTEM

(71) Applicant: Adbrain Ltd, London (GB)

(72) Inventors: Jason Atlas, London (GB); Zoltan Arvai, London (GB)

(21) Appl. No.: 15/214,752

(22) Filed: Jul. 20, 2016

(51) Int. Cl. H04L 29/08; G06F 9/54; H04L 29/06

(52) U.S. Cl. CPC H04L 67/10; H04L 63/0807; G06F 9/541; H04L 69/329

(57) ABSTRACT

The present disclosure provides a computing system, a method of operating the computing system, and a non-transitory tangible computer readable medium for providing cloud-computing services via a data communication network arrangement to one or more users. The computing system includes a data server arrangement for providing the cloud-computing services. The data server arrangement includes a tokenized accounting arrangement for controlling the data server arrangement for providing services to the one or more users. The data server arrangement further includes at least one application program interface (API) layer that is operable to manage and monitor user utilization of the data server arrangement via the tokenized accounting arrangement.

### TECHNICAL FIELD

The present disclosure relates to computing systems, in particular to cloud-based computing systems wherein a server arrangement serves one or more users that are remote from the server arrangement, and are coupled to the server arrangement via a data communication network. Moreover, the present disclosure relates to methods of operating aforementioned computing systems. Furthermore, the present disclosure relates to a non-transitory tangible computer readable medium having computer-readable instructions stored thereon, the computer-readable instructions being executable by a computerized device comprising processing hardware to execute aforementioned methods.

### BACKGROUND

During the evolution of computing systems, computers were initially very expensive apparatus and primarily used by large corporate organisations and research organisations. Such computing systems were often configured to serve multiple user terminals, and the user terminals had relatively modest computing capability. When inexpensive personal computers became available, these were initially isolated devices having modest computing power. Thereafter, with the development of the Internet® as a data communication system, networked computers became more popular. Later, “cloud-computing” became more popular, wherein user devices are coupled via a data communication network, for example the Internet® and/or a wireless telephonic communication network, to computing resources. By employing “cloud-computing”, considerable computing effort is executed remotely from user devices, for example smart phones and personal computers, in an arrangement of servers. Such a trend to “cloud-computing” has been possible on account of data communication networks having considerably more data bandwidth than hitherto, and the data communication networks being more reliable. “Cloud-computing” enables users to have access to greater computing resources, to larger databases, to a greater selection of software applications and so forth. An additional benefit of “cloud-computing” is that it enables data mining for monitoring user activity to be achieved, for example for purposes of targeted advertising and similar. In future, it is envisaged that “cloud-computing” will enable users to access artificial intelligence (AI) computing engines that will be capable of synthesizing human cognitive processes.

A contemporary issue arises with regard to “cloud-computing” concerning who pays for the arrangement of servers. In certain situations, data mining in respect of user activity, for example for targeted advertising purposes, pays for the arrangement of servers by way of receipt of advertising revenue from clients desiring to advertise to users. Alternatively, users may pay for the use of “cloud-computing” resources, for example by way of a monthly subscription and/or amount of data accessed or downloaded from the server arrangement.

From a viewpoint of operators of the arrangement of servers, user demand for “cloud-computing” servers potentially various as a function of time. For users to experience a responsive and reliable “cloud-computing” service, it is essential for operators of arrangements of servers, when providing the service, to ensure that sufficient computing resources are provided. Increasingly higher resolution of multimedia services, for example HDTV and 3-D video, causes a temporally increasing demand for data storage and data supply capacity from arrangements of servers providing “cloud-computing” services. Moreover, advanced encryption and encoding operations are also performed at the arrangements of servers, for example to circumvent pirating of multimedia data content, placing demands on data processing capacity of the arrangements of servers.

In cloud-computing, “elasticity” is defined as a degree to which a computer system of a “cloud” is able to adapt to workload changes by provisioning and de-provisioning resources in an autonomic manner, such that, at each point in time, available computing and database resources match a current demand as closely as possible. Under elastic pricing for cloud-computing resources, customers are charged based upon their time of usage and a degree of consumption of a cloud-computing service. An elastic pricing structure makes users keenly aware of a cost of doing business and consuming a resource, since the costs are borne by the users, or, in the enterprise world, from company budgets. Moreover, with an awareness of the costs comes more efficient and selective usage, thus resulting in less waste and lower costs for operators of “cloud-computing” services.

A number of factors such as, for, example, constant factors, seasonal factors, and lifecycle based factors, can cause an increase in consumption of cloud-computing resources. The constant factors would be, for example, given user numbers increasing month-by-month, wherein such constant factors may require a scaling up of the number of servers utilized to be able to handle increasing volumes of requests. Even if user numbers remain steady, there may be experienced constant growth in data storage consumption. In seasonal factors, for example, a given enterprise may be in an industry that experiences predictable growth and shrinkage during certain times of the year. Websites and web applications that cater for holiday shoppers, for instance, experience such a pattern of growth. Other factors may be based on lifecycle of a given enterprise. For example, enterprises usually experience a temporary growth phase during new product launches and marketing activities. High-spike growth phases usually last for a few weeks to a few months and then stabilize at a lower number.

Next, there will be considered designing growth patterns: permanent vs. temporary. A permanent pattern may be one that persists; once it has been applied it may change the baseline number of resources being used. For example, there might be created a storage unit that uses 100 Giga Byte (GB) per month and then there arises a need to increase the storage by 5 GB every month going forward. A temporary pattern may last only for some duration, for example during festivals, and at the end of that duration the resource usage may return to an original pattern of resource usage. For example, there might be needed 20 web servers to support a given users every month, but there then arises a need to double that number to handle a peak that a given site gets during a shopping season, for example Christmas or Diwali.

Next there will be considered operators while designing growth patterns. Planners can model a large number of different growth patterns in Plan-For-Cloud. For example, there might be five operators that people can use to address the majority of use cases: Add (+), Subtract (−), Increase by (%), Decrease by (%), and Set to (=).

As described above, the cloud-computing is an on-demand facility or functionality, that a customer can request from a provider. Thus, the customer does not incur heavy infrastructure or service costs, and simply pays according to the usage of resources. Additionally, the customer has the flexibility to release the resources if not required by the customer. Presently, there exist tools that enable monitoring of elastic costs and support deployment of services in a given cloud-computing arrangement. Primarily, these tools rely on server information to assess costs and obtain resource deployment information. However, a given customer eventually incurs additional unwanted expenditure due to garbage collection, server provisioning latency and so forth. In most cases, for customers using processing clusters on the given cloud-computing arrangement, it is desirable to deploy processing clusters (of computing resources) only when processing is essential since the deployment of processing clusters can be quite expensive. In aforementioned situations, savings in cost may be made using other suitable approaches to providing cloud-computing functionality. However, the presently used tools do not provide optimum cost reduction leading to an undesirable increase in expenditure for customers.

### SUMMARY

In light of the foregoing, there exists a need to provide customers with an effective, simple system to manage cloud-based computin resources and to keep a check on associated expenses.

The present disclosure seeks to provide a computing system for providing cloud-computing services via a data communication network arrangement to one or more users.

Moreover, the present disclosure further seeks to provide a method of operating a computing system for providing cloud-computing services via a data communication network arrangement to one or more users.

The present disclosure seeks to provide a non-transitory tangible computer readable medium comprising instructions for operating a computing system for providing cloud-computing services via a data communication network arrangement to one or more users.

According to an aspect of the present disclosure, there is provided a computing system for providing cloud-computing services via a data communication network arrangement to one or more users; the computing system includes a data server arrangement for providing the cloud-computing services; the he data server arrangement includes a tokenized accounting arrangement for controlling the data server arrangement for providing services to the one or more users; and the data server arrangement further includes at least one application program interface (API) layer that is operable to manage and monitor user utilization of the data server arrangement via the tokenized accounting arrangement.

In an embodiment, the at least one application program interface (API) layer is operable to make one or more clusters of servers of the data server arrangement available to be allocated to one or more users for implementing a given task, and to redeploy servers of the one or more clusters to be available to other users at completion of the given task.

In an embodiment, the at least one application program interface (API) layer is operable to collate information from tokens of the tokenized accounting arrangement corresponding to cloud-computing services provided to the one or more users for predicting temporal changes and/or temporal patterns in utilization of the data server arrangement for use in controlling provision of data server capacity for the data server arrangement.

In an embodiment, the tokenized accounting arrangement is operable to receive ticket requests from the one or more users for cloud-computing services, and to make cloud-computing services available to a given user of the one or more users after receiving a plurality of ticket requests from the given user. A ticket is essentially an authorization token that gives permission to access the resource.

In an embodiment, the given user is operable to inform the at least one application program interface (API) layer that the user's ticket request is completed, for enabling the tokenized accounting arrangement to redeploy servers of the one or more clusters to process ticket requests of other users.

According to another aspect of the present disclosure, there is provided a method of operating a computing system for providing cloud-computing services via a data communication network arrangement to one or more users; the method includes arranging for the computing system to include a data server arrangement for providing the cloud-computing services; the method further includes arranging for the data server arrangement to include at least one application program interface (API) layer that is operable to manage and monitor user utilization of the data server arrangement via a tokenized accounting arrangement; and the method furthermore includes using the tokenized accounting arrangement to control the data server arrangement for providing services to the one or more users.

In an embodiment, the method includes operating the at least one application program interface (API) layer to make one or more clusters of servers of the data server arrangement available for allocated one or more users for implementing a given task, and to redeploy servers of the one or more clusters to be available to other users at completion of the given task.

In one embodiment, the method also includes operating the at least one application program interface (API) layer to collate information from tokens of the tokenized accounting arrangement. The tokens may be corresponding to cloud-computing services provided to the one or more users for predicting temporal changes and/or temporal patterns in utilization of the data server arrangement for use in controlling provision of data server capacity for the data server arrangement.

In one embodiment, the method also includes operating the tokenized accounting arrangement to receive ticket requests from the one or more users for cloud-computing services, and to make cloud-computing services available to a given user of the one or more users after receiving a plurality of ticket requests from the given user.

In an embodiment, the method includes receiving, by the at least one application program interface (API) layer, an information from the given user that the user's ticket request is completed; and redeploying, by the tokenized arrangement, servers of the one or more clusters to process ticket requests of other users based on the received information.

According to another aspect of the present disclosure, there is provided a non-transitory tangible computer readable medium including instructions for operating a computing system for providing cloud-computing services via a data communication network arrangement to one or more users. The non-transitory tangible computer readable medium includes instructions for arranging for the computing system to include a data server arrangement for providing the cloud-computing services; arranging for the data server arrangement to include at least one application program interface (API) layer that is operable to manage and monitor user utilization of the data server arrangement via a tokenized accounting arrangement; and using the tokenized accounting arrangement to control the server arrangement for providing services to the one or more users.

In an embodiment, the non-transitory tangible computer readable medium further includes instructions for operating the at least one application program interface (API) layer to make one or more clusters of servers of the data server arrangement available for allocated one or more users for implementing a given task, and to redeploy servers of the one or more clusters to be available to other users at completion of the given task.

In an embodiment, the non-transitory tangible computer readable medium further includes instructions for operating the at least one application program interface (API) layer to collate information from tokens of the tokenized accounting arrangement corresponding to cloud-computing services provided to the one or more users for predicting temporal changes and/or temporal patterns in utilization of the data server arrangement for use in controlling provision of data server capacity for the data server arrangement.

In an embodiment, the non-transitory tangible computer readable medium further includes instructions for operating the tokenized accounting arrangement to receiver ticket requests from the one or more users for cloud-computing services, and to make cloud-computing services available to a given user of the one or more users after receiving a plurality of ticket requests from the given user.

In an embodiment, the non-transitory tangible computer readable medium further includes instructions for receiving an information from the given user that the user's ticket request is completed; and redeploying servers of the one or more clusters to process ticket requests of other users based on the received information.

### BRIEF DESCRIPTION OF THE FIGURES

The foregoing summary, as well as the following detailed description of preferred embodiments, is better understood when read in conjunction with the appended drawings. For the purposes of illustration, there is shown in the drawings exemplary embodiments; however, the present disclosure is not limited to the specific methods and instrumentalities disclosed. In the drawings:

FIGS. 1A-1B are illustrations of various exemplary systems, in accordance with various embodiments of the present disclosure;

FIG. 2 is an illustration of a block diagram of a data server arrangement, in accordance with an embodiment of the present disclosure;

FIGS. 3A-3C are flowcharts providing an illustration of an exemplary method of operating a computing system for providing cloud-computing services via a data communication network arrangement to one or more users, in accordance with an embodiment of the present disclosure; and

FIG. 4 is an illustration of an exemplary topology for managing scaling up of a cloud computing service provided by a service provider, in accordance with an embodiment of the present disclosure.

### DETAILED DESCRIPTION

In the disclosure herein, consideration or use of a particular element number in a given diagram (FIG.) or corresponding descriptive material can encompass the same, an equivalent, or an analogous element number identified in another diagram (FIG.) or descriptive material corresponding thereto

In the Detailed Description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic may be described in connection with an embodiment, it may be within the knowledge of one skilled in the art to effect such feature, structure, or characteristic in connection with other embodiments whether or not explicitly described.

The following detailed description refers to the accompanying drawings that in which there are provided illustrations of exemplary embodiments. Other embodiments are possible, and modifications can be made to the embodiments of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

### Exemplary Definitions

As used herein, a “computing device” or user device includes a single device or a combination of multiple devices, which may be capable of communicating, and exchanging one or messages with other devices present in a data communication network.

As used herein, a “cloud-computing” refers to an approach of using a network including an arrangement of servers hosted on the Internet® to store, manage, and process data. The cloud-computing may provide shared processing resources and data to computers and other devices on demand.

As used herein, a “cloud system” refers to a system for providing cloud-computing services via a data communication network arrangement to one or more user.

Further, as used herein, a “cloud-computing network” refers to a network including multiple devices, such as, but not limited to, servers, computers, routers, gateways, storage devices, and so forth, and is configured to provide cloud-computing services to one or more users.

Furthermore, as used herein, a “data server arrangement” includes a number of servers arranged in the cloud-computing network and the servers are capable of providing one or more services to the one or more users. The servers in the data server arrangement may be a single device or may include multiple devices. Furthermore, the data server arrangement may include a software, hardware, firmware, or combination of these.

Furthermore, as used herein, a “tokenized accounting arrangement” refers to an arrangement or device configured to control the data server arrangement for providing services to the one or more users. The tokenized account arrangement may include a software, hardware, firmware, or combination of these.

As used herein, an application program interface (API) layer is configured to manage and monitor user utilization of the data server arrangement via the tokenized accounting arrangement. The API may include a software, hardware, firmware, or combination of these.

### Overview

The present disclosure provides a computing system, a method and a non-transitory tangible computer readable medium for providing cloud-computing services via a data communication network arrangement to one or more users, for example to a single user, alternatively to a plurality of users. The cloud-computing services are provided by one or more service providers in the data communication network, for example from a plurality of service providers. The present disclosure provides a system that allows a user of elastic resources or services to have atomic control of his/her elastic resources, with application cognizance. The present disclosure provides computing systems and methods that give a business or an enterprise an ability to control their elastic or dynamic costs related to availing cloud-computing services into a more predictable, as well as lean model (only paying for what the business or the enterprise uses) has enormous repercussions in cloud-computing markets. Now, two specific use case implementations of the disclosed computing system will be explained in detail. Furthermore, an example of how the client API for integrating into elastic computing systems can be done, and how the disclosed computing systems can be managed will be explained. Though not shown and not necessary for the disclosed systems and the methods can be used for managing computing systems having dynamic elastic deployments of resources such as, but not limited to, servers.

According to an aspect of the present disclosure, there is provided a computing system for providing cloud-computing services via a data communication network arrangement to one or more users, wherein the computing system includes:

a data server arrangement for providing the cloud-computing services, characterized in that the data server arrangement includes:
a tokenized accounting arrangement configured to control the data server arrangement for providing services to the one or more users; and
at least one application program interface (API) layer configured to manage and monitor user utilization of the data server arrangement via the tokenized accounting arrangement. The first view pages will have flowcharts of the overall architecture, followed by the workflow for how it actually works at the code execution level, and finally, by a flow chart showing how systems are integrated.

According to another aspect, there is provided a method of operating a computing system for providing cloud-computing services via a data communication network arrangement to one or more users, characterized in that the method includes:
(i) arranging for the computing system to include a data server arrangement for providing the cloud-computing services;
(ii) arranging for the data server arrangement to include at least one application program interface (API) layer that is operable to manage and monitor user utilization of the data server arrangement via a tokenized accounting arrangement; and
(iii) using the tokenized accounting arrangement to control the server arrangement for providing services to the one or more users.

According to yet another aspect of the present disclosure, there is provided a non-transitory tangible computer readable medium comprising instructions for operating a computing system for providing cloud-computing services via a data communication network arrangement to one or more users, the non-transitory tangible computer readable medium comprising instructions for:

arranging for the computing system to include a data server arrangement for providing the cloud-computing services;

arranging for the data server arrangement to include at least one application program interface (API) layer that is operable to manage and monitor user utilization of the data server arrangement via a tokenized accounting arrangement; and

using the tokenized accounting arrangement to control the server arrangement for providing services to the one or more users.

### Exemplary Embodiments of Systems

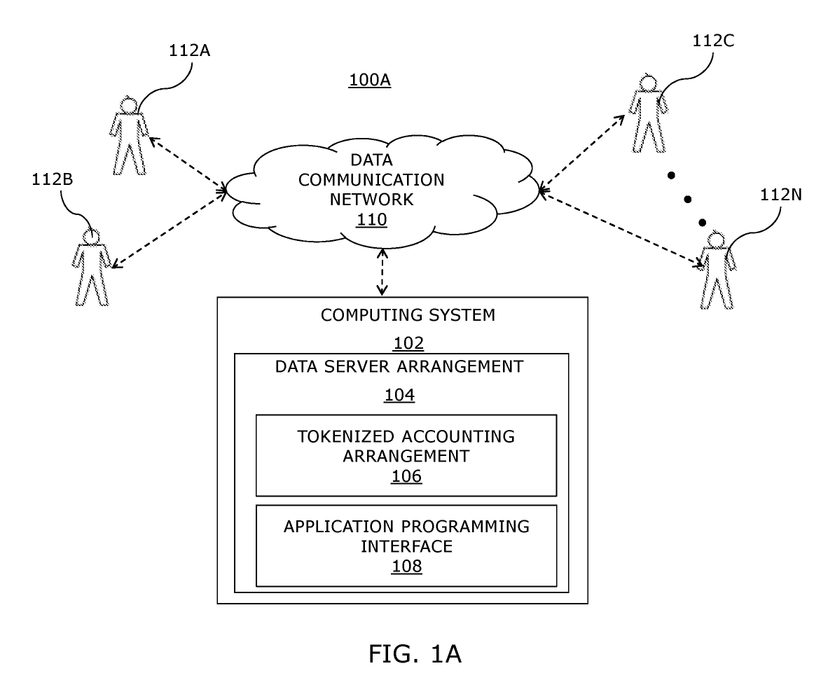

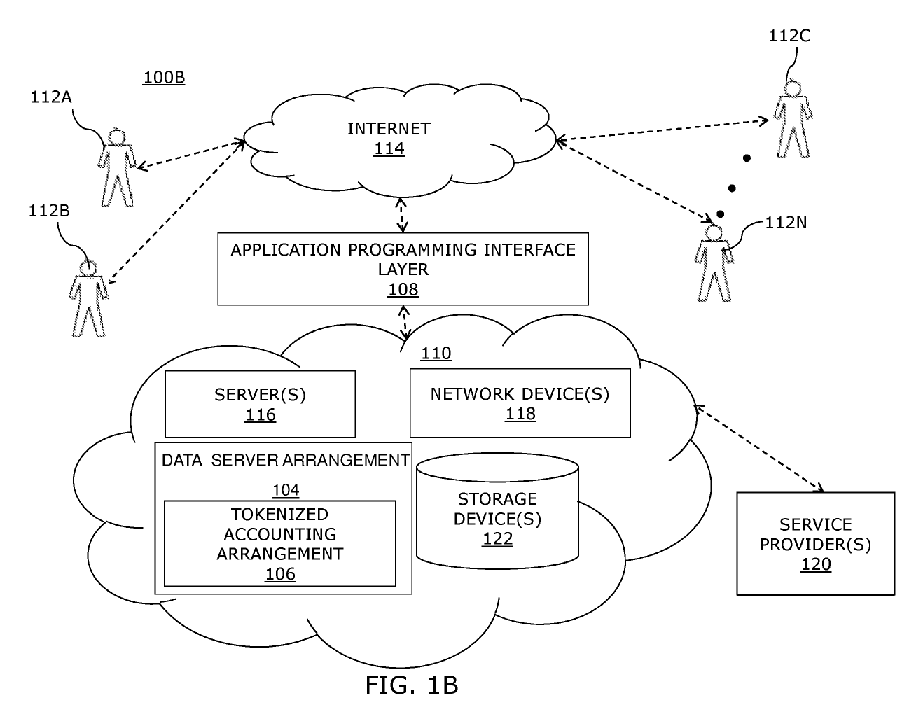

In FIGS. 1A-1B, there are shown illustrations of exemplary systems 100A-100B, in accordance with various embodiments of the present disclosure. As shown in FIG. 1A, the system 100A includes a computing system 102, and one or more users 112A-112N. The computing system 102 is operable to provide cloud-computing services via a data communication network arrangement 110 (herein after also referred as the data communication network 110) to the one or more users 112A-112N. The computing system 102 includes a data server arrangement 104 for providing the cloud-computing services. The data server arrangement 104 further includes a tokenized accounting arrangement 106 and at least one application program interface (API) layer 108. The computing system 102 is operable to control the data server arrangement 104 for providing services to the one or more users 112A-112N. The computing system 102 is further operable to manage and monitor user utilization of the data server arrangement 104. A cloud-computing service may consume one or more cloud-computing resources of the data server arrangement for execution and completion. Though not shown, the data server arrangement 104 may further include a number of servers and each of the server may include its own API layer 108.

In one embodiment, the computing system 102 is operable to make one or more clusters of the servers of the data server arrangement 104 available for allocated one or more users 112A-112N for implementing a given task. The users 112A-112N may send a request to the computing system via a client program running on a computing device (not shown) of the users 112A-112N, which may be received by the tokenized accounting arrangement 106. The user's request may be assigned a token and resources from the available set of servers, and so forth, of the data server arrangement 104. In an embodiment, on completion a given task corresponding to the request, the users 112A-112N or the client programs may inform the computing system 102 about the completion.

In an embodiment, the computing system 102 is operable to collate information from tokens of the tokenized accounting arrangement 106 corresponding to cloud-computing services provided to the one or more users 112A-112N for predicting temporal changes and/or temporal patterns in utilization of the data server arrangement 104 for use in controlling provision of data server capacity for the data server arrangement 104.

In an embodiment, the computing system 102 is also operable to receive ticket requests from the one or more users 112A-112N for cloud-computing services, and to make cloud-computing services available to a given user of the one or more users 112A-112N after receiving a number of ticket requests from the given user. In an embodiment, the computing system 102 is also operable to redeploy servers of the one or more clusters to be available to other users at completion of the given task.

In some embodiments, the computing system 102 is further operable to inform the at least one application program interface (API) layer that the user's ticket request is completed, for enabling the tokenized accounting arrangement to redeploy servers of the one or more clusters to process ticket requests of other users. It will be appreciated that there are optionally a plurality of application program interface (API) layers employed.

FIG. 1B illustrates the system 100B, where the data communication network 110 includes multiple devices, such as a data server arrangement 104, a number of servers 116, network devices 118, and storage devices 122. Though not shown, the data communication network 110 may include a number of other devices like sensors, computing devices, website hosting servers, and so forth. The data communication network 110 may be a cloud-based network. Furthermore, the data communication network 110 may include the tokenized accounting arrangement 106.

The system 100B also includes the API layer 108 that may be built directly into service tier of a cloud service. This may help in managing the up-scaling and down-scaling of costly resources in the data communication network 110.

In an embodiment, the cloud-computing services may be provided by service providers 120. The service providers 120 may be a human or a company providing the cloud services through the data communication network 110. The users 112A-112N may request one or more cloud services provided by the service providers 120 via a network such as Internet 114.

The network devices 118 may enable communication between the devices present in the data communication network 110. Examples of the network devices 118 may include, such as, but not limited to, network firewalls, switches, repeaters, hubs, routers, proxy servers, protocol convertors, bridge, modems, gateways, and so forth.

The servers 116 may include hardware device, software modules, firmware, and combination of these. The servers 116 are the device operable to send, receive, and process data from other devices such as the client devices. Furthermore, the servers 116 may process requests for example, printing request, gaming request, email access request, and so forth, received from other device such as, client devices or client programs. Furthermore, the servers 116 may enable data sharing and resources' sharing among multiple devices in the data communication network 110. Examples of the servers may include, such as, but not limited to, file servers, print servers, web servers, game servers, mail servers, and application servers.

The storage devices 122 may include hardware devices, software modules, firmware, and combination of these, and may be configured to store data and information.

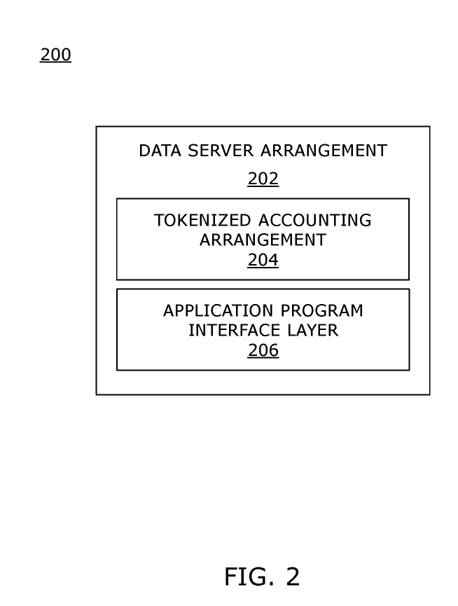

FIG. 2 is a block diagram 200 showing system elements of a data server arrangement 202, in accordance with an embodiment of the present disclosure. As shown, the data server arrangement 202 includes a tokenized accounting arrangement 204 and at least one application program interface (API) layer 206; optionally, there are a plurality of application program interface (API) layers 206 employed. The tokenized accounting arrangement 204 is operable to control the data server arrangement 202 for providing services to the one or more users.

The at least one API layer 206 is configured to manage and monitor user utilization of the data server arrangement 202 via the tokenized accounting arrangement 204. In an embodiment, the at least one API layer 206 is operable to manage and monitor utilization of cloud-computing resources or services in the data server arrangement 202. Optionally, the at least one API layer 206 is also operable to implement one or more clusters of the servers 116 of the data server arrangement 202. The clusters of the servers 116 may be formed based on the resource requirement for processing a request ticket (or token) and resource availability. The servers 116 may be available for allocated one or more users 112A-112N for implementing a given task. In one embodiment, the at least one API layer 206 may be operable to redeploy the servers 116 of the one or more clusters to be available to other users of the users 112A-112N at completion of the given task.

In one embodiment, the at least one API layer 206 may be operable to collate information from tokens of the tokenized accounting arrangement 204 corresponding to cloud-computing services provided to the one or more users 112A-112N for predicting temporal changes and/or temporal patterns in utilization of the data server arrangement 202 for use in controlling provision of data server capacity for the data server arrangement 202.

Optionally, the tokenized accounting arrangement 204 is operable to receive ticket requests from the one or more users for cloud-computing services. Furthermore, the tokenized accounting arrangement may be operable to make cloud-computing services available to a given user of the one or more users 112A-112N after receiving a number of ticket requests from the given user. The given user may inform the at least one API layer 206 that the user's ticket request is completed, for enabling the tokenized accounting arrangement 204 to redeploy servers of the one or more clusters to process ticket requests of other users of the users 112A-112N.

As discussed with reference to FIGS. 1A-1B, the users 112A-112N may access the at least one API layer 206 through one or more API call requests described in detail with reference to subsequent figures.

### Exemplary Method Flowcharts

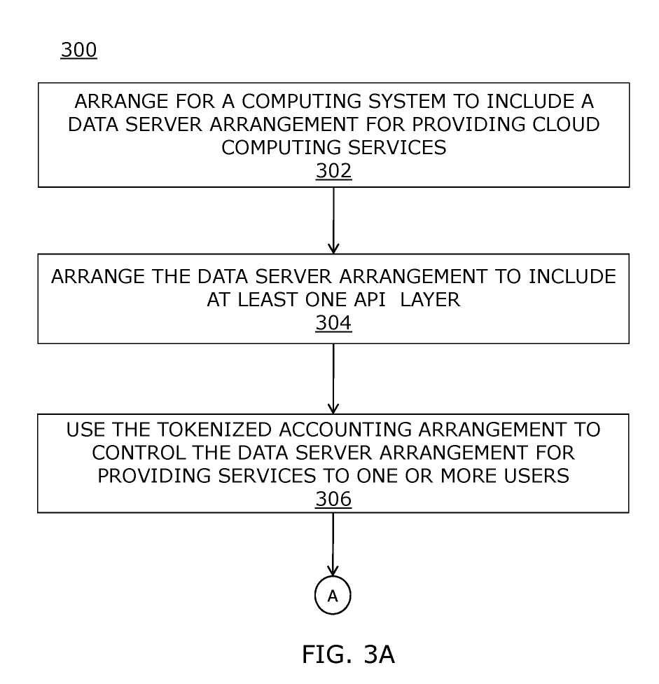

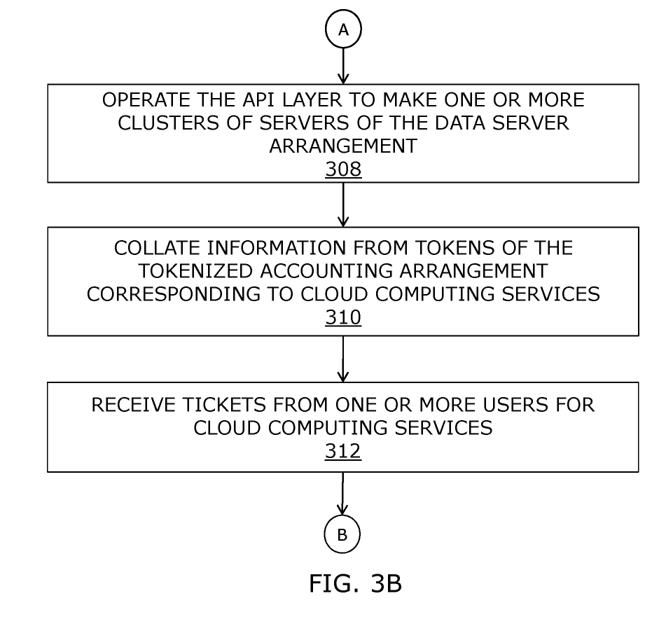

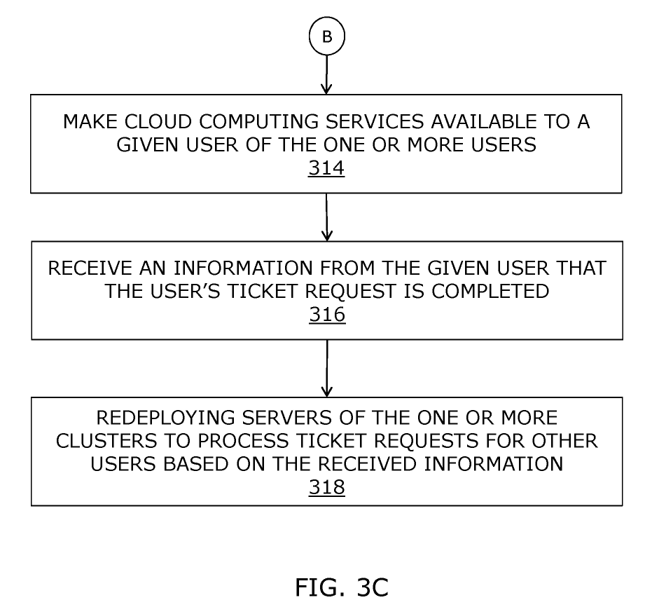

FIGS. 3A-3C is a flowchart in which that is illustrated an exemplary method 300 of operating a computing system for providing cloud-computing services via a data communication network arrangement to one or more users, in accordance with an embodiment of the present disclosure; optionally, there are a plurality of users. As discussed with reference to FIG. 1A, the computing system 102 is operable to provide cloud-computing services via the data communication network arrangement 110 to the one or more users 112A-112N.

At a step 302, a computing system including a data server arrangement is arranged for providing one or more cloud computing services. In an embodiment, the computing system 102 including the data server arrangement 104 is arranged to implement an embodiment of the present disclosure. The data server arrangement 104 may include multiple servers and other resources like storage devices, and so forth.

At a step 304, the data server arrangement is arranged to include an API layer. In an embodiment, the data server arrangement 104 is arranged to include the aforementioned at least one API layer 108 that is operable to manage and monitor user utilization of the data server arrangement 104 via the tokenized accounting arrangement 106. Then, at a step 306, a tokenized accounting arrangement is used to control the data server arrangement for providing services to one or more users. In an embodiment, the tokenized accounting arrangement 106 is used to control the data server arrangement 104 for providing cloud-computing services to one or more of the users 112A-112N.

At a step 308, the API layer operates to make one or more clusters of servers function as the data server arrangement. In an embodiment, the API layer 108 makes one or more clusters of servers function as the data server arrangement 104.

Further, at a step 310, information from tokens of the tokenized accounting arrangement corresponding to cloud-computing services is collated. In one embodiment, the at least one API layer 108 collates the information from tokens of the tokenized accounting arrangement 106 corresponding to cloud-computing services provided to the one or more users for predicting temporal changes and/or temporal patterns in utilization of the data server arrangement 104 for use in controlling provision of data server capacity for the data server arrangement 104.

Thereafter, at a step 312, one or more ticket requests are received from one or more users for cloud-computing services. In one embodiment, the tokenized accounting arrangement 106 receives the one or more ticket requests. Then, at a step 314, the cloud-computing services are made available to a given user of the one or more users. In one embodiment, the tokenized accounting arrangement 106 makes the cloud-computing services available to the given user of the users 112A-112N.

Thereafter, at a step 316, an information from the given user is received to inform that the user's ticket request is complete. In one embodiment, the API layer 108 receives the information from the given user. Then, at a step 318, servers of the one or more clusters are redeployed to process ticket requests for other users based on the received information. In one embodiment, the tokenized accounting arrangement 106 redeploys servers to process ticket requests for other users based on the received information.

### Exemplary Scenarios/Use Cases

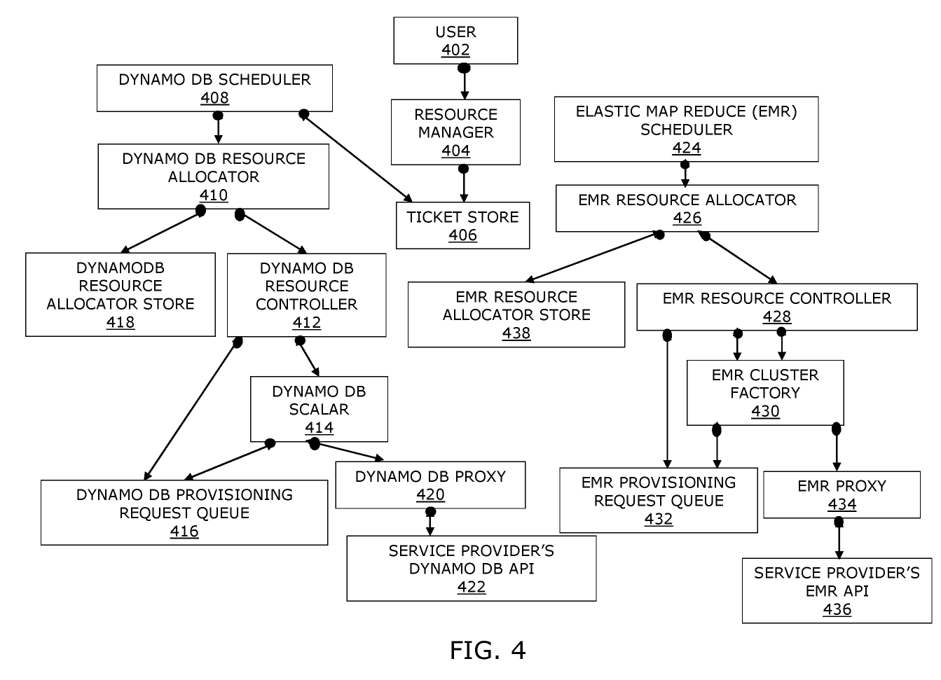

In FIG. 4, there is provided an illustration of an exemplary topology 400 for managing scaling up of a cloud computing service, such as an Elastic Map Reduce (EMR) service, provided by a service provider.

The EMR may be a service provided by a service provider and the EMR service may be used to create “Spark clusters” and to run various kinds of jobs on them. A spark cluster may refer to a cluster of one or more servers of a data server arrangement of the disclosed computing system (for example, computing system 102). Many business processes require jobs to be run on Spark clusters, sometimes for quite long periods of time.

As shown, the topology 400 includes multiple entities and modules; primarily, a user 402 may access one or more of the modules for accessing a service or for running job requests. The user 402 may get a ticket corresponding to the request of the user 402, an allocation status from a resource manager 404. Furthermore, the user 402 may be operable to notify the resource manager 404 about keeping a request alive and/or when the request is complete.

The resource manager 404 may receive a request for accessing the cloud computing service from the user 402. The resource manager 404 may ensure that programs such as, but not limiting to, Virtual Cloud Machine (VCM) running on user's computing device for example, a computer can easily create and destroy Spark clusters, while also minimizing costs. The resource manager 404 is operable to insert a ticket in a ticket store 406 and get a ticket from the ticket store 406. The ticket may be the ticket corresponding to the request of the user 402. The Resource manager 404 is also operable to update a status of last live ticket in the ticket store 406.

Usually, the EMR pricing is simple and predictable, and the user 402 may pay an hourly rate for every instance hour the user 402 use (so a 10-node cluster running for 10 hours costs the same as a 100-node cluster running for 1 hour). The hourly rate depends on the instance type used (e.g. standard, high central processing unit (CPU), high memory, high storage, etc.). Hourly prices may range from $0.011/hour to $0.27/hour ($94/year to $2367/year); $ denoted USD (US fiat currency). Furthermore, the user 402 may be charged from the time the cluster (i.e. the server cluster) begins processing until it is terminated. Partial hours may be rounded up when performing accounting computations.

While scaling the EMR service, another consideration is optionally that it can take a significant amount of time to create a cluster. Using conventional models, creating and destroying the clusters of server or resources on demand may result in potential wastage and unnecessary latency.

In an exemplary scenario, when there are three jobs, all requiring a cluster of 10×“c3.8xlarge” instances, which may always take 10 minutes to provision. The job details are shown in Table 1 below:

| | | Provisioning | Processing |
|---|---|---|---|
| Job# | Start | Time | Time |
| 1 | 00:00 | 10 minutes | 30 minutes |
| 2 | 00:55 | 10 minutes | 70 minutes |
| 3 | 2:25 | 10 minutes | 30 minutes |

The processing of above three jobs may incur a total cost of 40 hours of charges, because jobs 1 and 3 may be rounded up to 1 hour (×10 instances) and job 2 is rounded up to 2 hours (×10 instances). Furthermore, there is a total of 20 minutes of unnecessary processing latency because of re-provisioning clusters which already existed in a suitable form.

When the clusters are re-used, a situation may arise, as follows: after it has finished processing Job #1, the cluster is kept alive. When Job #2 comes along, it is processed immediately by the same cluster, and likewise for Job #3. Total uptime is just under 3 hours, which is rounded up to 3 hours (×10 instances)—a cost saving of 25%. Additionally only 10 minutes are spent provisioning instead of 30 minutes, which means that Jobs #2 and #3 may be completed earlier in the day.

The resource manager 404 is operable to get for status and update status of a ticket request from and to an EMR scheduler 424. The EMR scheduler 424 is operable to release a spark cluster, get spark cluster handle to an EMR resource allocator 426.

The EMR resource allocator 426 is operable to update spark cluster details, get spark cluster details, and add spark cluster details to/from an EMR resource allocator store 438. The EMR resource allocator 426 is also operable to release a cluster, and request a cluster to/from an EMR resource controller 428.

The EMR resource controller 428 is operable to notify allocation completed information to the EMR scheduler 424. Furthermore, the EMR resource controller 428 is operable to serve waiting requests (EMR), to serve updating requests (EMR) to an EMR cluster factory 430, and to add request (EMR) to/from an EMR provisioning request queue 432.

The EMR cluster factory 430 is operable to set to completed (EMR), get next waiting requests (EMR), to set to updating (EMR), to get updating requests (EMR) to/from the EMR provisioning request queue 432. The EMR cluster factory 430 is further operable to send a create spark cluster request (or API call) to an EMR proxy 434. The EMR cluster factory 430 is further operable to get cluster status from the EMR proxy 434.

The EMR proxy 434 is operable to run job flow and to describe cluster to the service provider's EMR API 436.

In one embodiment, the resource manager 404 may use the EMR Scheduler 424 that is operable to function as follows (assuming an empty computing system initially and all resources available, with no jobs running and using the resources): When a new ‘ticket’ is requested from the user 402, then the EMR resource allocator 426 may create a new cluster of servers immediately. When the cluster has finished provisioning, the EMR resource allocator 426 may mark the ticket as ‘Available’ with a handle of the cluster's “Job Flow Id”. The user's computing device's program is then free to run as many steps on the cluster it requires. Details of this cluster may be added to an EMR resource allocator store 438, and the cluster may be marked as ‘In use’. In one embodiment, when the program has finished with the cluster, the user 402 may inform the EMR resource allocator 426 that the ticket is ‘Completed’. The Resource Manager 404 or more specifically may flag the cluster as idle in the ticket store 406, but may not destroy it immediately.

In one embodiment, when the next ticket request comes along, the resource manager 404 first checks the ticket store 406 to see if any compatible clusters already exist, in a not-in-use state. If such a cluster is found, the ticket is marked as “Available” immediately, with the “Job Flow Id” of the existing cluster as its resource handle. The cluster is marked as “In Use” again. If no such cluster is found, one is created in the usual way by the resource manager 404.

So that the clusters do not last forever, namely temporally limited in duration, a separate garbage-collection process may regularly check for idle clusters, which are within a few minutes of entering a new charging hour. The idle clusters may refer to clusters of servers that are not in use currently; for example, an idle cluster, which was first created 56 minutes ago is regarded as not being in use currently. The resource manager 404 may destroy such idle clusters, means the servers of the idle clusters are released and may be redeployed for other job requests. For the purpose of cluster re-use, the requested cluster, and the existing cluster must have the same:

(a) Master instance type;
(b) Slave instance type;
(c) Instance count; and
(d) Configurations string (excluding the “fs.s3.consistent.metadata.tableName” setting).

Next, there will be described subtleties of the EMR scheduling Algorithm of the resource manager 404. In an embodiment, when checking for a cluster to reuse, the resource manager 404 compares configurations settings excluding the “fs.s3.consistent.metadata.tableName” property if it exists for the two clusters. Therefore, the ticket request and the cluster can have different table names here and the cluster will still be reused. This is because the table name will be generated by the client program which requested the cluster, and will be different for every cluster.

In some embodiments, a cluster may not be reused, for example if the steps that run on the cluster may likely to fill irreversibly the cluster's local storage. Therefore, it may be possible to specify in the ticket request that re-use of the particular cluster is not allowed. When this is done, the resource manager 404 may always create a new cluster for that ticket, and this cluster is flagged in the resource manager 404 as not being available for re-use by later tickets. Like other unused clusters, the created cluster will be destroyed and/or released just before it enters another charging hour.

In another embodiment, the resource manager 404 may re-use clusters which are compatible with, but not identical to, the requested cluster. For example re-use might occur if there was a free 10-node cluster and the job requested an 8-node cluster with the same configurations and instance types.

The resource manager 404 also configured to perform cluster tagging. The cluster tagging may refer to adding a series of key/value pairs to the cluster, and various reporting tools may be used to break down cluster costs by these tags. The resource manager 404 may populate the “Tags” property when requesting a ticket. The format of Tags may include, but is not limited to, “key1=value1,key2=value2” etc. Keys and values may be separated by an equal to symbol i.e., “=” and successive pairs are separated by a comma i.e. ‘,’. In one embodiment, the resource manager 404 may not support escaping characters in tag names and values, so usage of “=” and “,” may be avoided in key names and values. The System has the ability to read, or reject any UTF-8 character.

In some embodiments, when the resource manager 404 creates a new cluster of server or resources to fulfil a ticket, it tags the cluster with the tags specified in the ticket's Tags property.

In an embodiment, when the resource manager 404 re-uses a cluster to fulfil a ticket, it replaces any tags on the cluster with the tags specified in the new ticket's Tags property. The ticket store 406 may receive and manage tickets from the user's computing device or from programs running on the computing device of the user 402.

In an embodiment, when the resource manager 404 releases (but does not destroy) a cluster because a ticket is no longer using it, no change is made to the cluster's tags. The tags may only be changed when and if another ticket re-uses the cluster.

The resource manager 404 may manage provisioning of the job requests. The service provider has an API layer. A service provider's EMR API is configured to communicate with the service provider's API.

In an embodiment, when the resource manager 404 is configured to manage scaling of a database, the database may store some of the data required to perform business processes. These business processes may require significant levels of I/O from/to database tables, and for considerable periods of time. In one embodiment, the resource manager 404 is operable to ensure that sufficient input output (I/O) is provided for jobs, while also minimizing costs. Usually, there is employed a database pricing model that is as follows: the user 402 can ‘provision’ a specified amount of reads-per-second (and/or writes-per-second) for any table. Once this has been done, via a service provider's API call, the service provider may guarantee to provide sufficient infrastructure or resources (servers, storage devices etc.) to support the specified level of I/O. The user 402 may be charged based on the provisioning level (reads and/or writes-per-second) requested, whether or not actual reads/writes are performed this fast—or at all. The user 402 may be allowed to increase the level of provisioning as often as he/she likes.

Furthermore, the user 402 can only decrease the level of provisioning n-times per table per UTC day, wherein “n” is an integer. For example, if the user 402 scales down a table nine times for reads, and three times for writes, then any subsequent downscaling for reads or writes made for that table before midnight UTC may fail. It will be appreciated that for the description purposes, the official limit for the down-scales is assumed to be 4 per UTC day.

The input/output (I/O), with reference to the foregoing, is measured in ‘read-capacity-units’ (reads per second)—rcu; and ‘write-capacity-units’ (writes per second)—wcu. If the user 402 scales up every time a new job comes along, and scales down when it finishes, then the user 402 may be exposed to pay for a great deal of scaled-up infrastructure that the user 402 is not using—because down scale request may start failing soon.

The resource manager 402 is configured to provide management of the database for preventing wasted bandwidth by avoiding failed scale-down requests. The resource manager 402 may use one or more modules of a scheduler 408. The ticket store 406 is operable to get status of the requests or ticket requests and update statuses from the Scheduler 408 and the EMR scheduler 424.

The scheduler 408 is operable to get current scale, request scale up to, request scale down, get resource handle, and receive scale down cost from a resource allocator 410. The scheduler 408 is operable to notify allocation complete information to a resource controller 412.

The resource allocator 410 is operable to request scale down and scale up from the resource controller 412. The resource allocator 410 is also operable to, scale down count for, set scale, get scale, add scale down to history in a resource allocator store 418.

The resource controller 412 is operable to add request (DBD) in a provisioning request queue 416, and serve waiting requests (DBD) and serve updating requests (DBD) in a scalar 414.

The scalar 414 is operable to set to completed (DBD), get next waiting requests (DBD), set to updating (DBD), and get updating requests to the provisioning request queue 416. The scalar 414 is also operable to scale table reads to, and get table status to/from a proxy 420.

The proxy 420 is operable to describe table and update table in a service provider's API 422.

In an embodiment, an algorithm is used by the scheduler 408 for managing the database. The algorithm includes steps of:

(i) Dividing the day up into ‘slots’—i.e. assuming a four-downscale-per day limit, these would be 00:00, 06:00, 12:00 and 18:00)
(ii) When a job appears, processing of the job does not occur immediately. Instead, a period is waited until the start of the next slot.
(iii) When a slot starts (e.g. at 06:00), processing the waiting jobs occurs.
(iv) When the now-processing jobs have all completed, scaling down to the minimum level of I/O is employed.

By using such an approach, the scheduler 408 may ensure that however many jobs are received by the resource manager 404 and at what times through the day, the resource manager 404 may never attempt to scale down more than four times. Of course this comes at the cost of any new job having to wait up to 2 hours (24 hours per day divided by 12 slots) before it even starts processing.

There are some additional subtleties of the Algorithm to be appreciated. In the step (iii) above, the scheduler 408 may not actually start all waiting jobs; the scheduler 408 may start enough jobs to fill up the maximum I/O that can be requested per table. Thus, for example, if there are jobs requiring 10K rcu, 60K rcu and 20K rcu (and assuming the max rcu for the table is 80K), then only the first two of these jobs are started at the beginning of the slot.

Furthermore, with reference to the foregoing: at the beginning of the slot, the resource manager 404 takes jobs in strict creation order to avoid starvation (namely, experience a lack of jobs to be executed). For example, the resource manager 404 may fit the 60K and 20K jobs into the available 80K. If the resource manager 404 did not take the jobs in creation order there would be a risk that large jobs would be continually overtaken by smaller jobs which were able to fit into the available bandwidth.

In an embodiment, when any job completes, the algorithm checks to see if any waiting job can now fit into the available I/O bandwidth. From the previous example, this would mean that the 20K job would start being processed as soon as the 10K or the 60K job completed. Such a rule may be applied both to jobs waiting (because they couldn't be fitted in at the start of the slot), and to jobs which have appeared since the slot started. Moreover, in this case we use the oldest job which will fit, rather than going strictly first-in-first-out as at the start of a slot. For this purpose, ‘available bandwidth’ means the maximum for a table (e.g. 80K) minus the total of any Allocated (i.e. running) tickets. This may mean that the scheduler 408 may scale up the table if the current scaling is less than the maximum for the table.

In one embodiment, when the resource manager 404 completes all available jobs for a particular resource, scaling down of the database may be performed. This may occur after a slight delay serving following two purposes, i.e. if there is a job already waiting which could not be started because there was insufficient bandwidth, the delay may provide a last chance for the job to be scheduled after all other jobs have been completed, and the delay may allow clients which have varying I/O requirements over the lifespan of their work to mark one ticket as completed then to create another ticket, without the risk of having to wait for the next ‘slot’ before the second ticket becomes ‘Available’.

In an embodiment, if a time slot is ‘wasted’—i.e. no scale-downs occurred in that 6 hour slot—then the scheduler 408 may ‘save up’ that wasted slot. This means that if a job arrives during another slot later in the day, that job may be allocated immediately rather than waiting for the next slot-start.

In an embodiment, the minimum permissible scaling level for the database for reads is 1 rcu and for writes is 1 wcu. Therefore, when a ticket or set of tickets requires 0 reads or 0 writes, the actual resulting scaling request will be for 1 rcu (or 1 wcu).

Furthermore, in one example embodiment, the resource manager 404 may not allocate any new tickets when there are currently any tickets in status “AllocationRequested”. This is because at this point it is hard to be sure what the actual in-use/available bandwidths are is practice. For this reason, at the start of a slot, the resource manager 404 may wait until any “AllocationRequested” tickets are actually allocated before making further scheduling decisions. Furthermore, the wait may occur within the Refresh( ) call so that there is not ‘missed the start of the slot’. In another embodiment, when not at the start of a slot, the resource manager 404 does anything if there are any “AllocationRequested” tickets. There may not be a need to wait in this case, as in some future Refresh call the tickets will have moved on to Allocated.

Furthermore, there may be a requirement that a base-load of provisioning remains available at all times, for use by processes not under Resource Manager's control. Accordingly when the resource manager 404 scales down, it scales down to this level not to 1 wcu/rcu, which is the AWS minimum. When a ticket for, for example, 15,000 wcu is requested, the resulting write capacity will be 25,000 wcu (10K+15K).

In an exemplary scenario, the resource manager 404 allocates and de-allocates resource over the course of a couple of days in production. Sometimes, the user 402 may request a ticket but not actually start using the table for a while. For example, this can happen if the user 402 needs to bring up another resource like a Spark Cluster before it can start processing. Sometimes, the user 402 may slightly over-estimate or under-estimate the I/O it needs. Sometimes, the user 402 may not use the table continuously for the duration of a ticket (for instance if it needs to do other processing.

In an example of API integration using the database, it will be appreciated that this is an example of one API interface of the user's computing device, in practice. It is feasible to use this pattern for any dynamically allocated elastic service. When the user 402 wishes to start a job which will require database bandwidth, it must request a ‘ticket’ from the API layer 108 for example, the service provider's API 422. The request must specify the required bandwidth (rcu and/or wcu). The service provider's API layer 422 may return a ticket ID to the client. The user 402 must then repeatedly request the status of the ticket. Initially, the status will be ‘not available’, meaning that the resource is not provisioned (or is in use by something else) and the client must not start performing I/O. Eventually the status will be returned as ‘available’, meaning that the resource is provisioned and free, and the client may start performing I/O. When the client has completed its task and no longer needs to perform I/O, it must notify the API layer 108 that the ticket is completed, meaning that the resource will either be downscaled or the bandwidth will be made available to another user. In order to avoid hung users retaining resources for ever, the user must periodically notify the API layer 108 that the ticket is still required. If this is not done within a configurable period of time, the ticket is ‘timed out’ and the resource it represents becomes available for other clients or for downscaling.

As described with reference to FIG. 1A-1B, the API layer 108 is configured to execute the following API calls that may be used by the users 112A-112N to achieve the steps discussed above. The API calls include, for example: creating a ticket

### Method: POST

Table 2 includes parameters used in the API call for creating a ticket and their meaning:

| Parameter Name | Meaning |
|---|---|
| <ResourceType> | The type of the resource required (Maps |
| | internally to a database table) |
| | Possible values are: |
| | CookiSyncA2P |
| | CookiSyncP2A |
| <rcu> | The rate at which the client expects to be |
| | able to read from the resource (i.e. the |
| | database table). Use 0 for no writes |
| | expected. |
| <wcu> | The rate at which the user expects to be able |
| | to write to the resource (the database table). |
| | Use 0 for no writes expected. |
| <priority> | Reserved for future use. Use 1. |
| <noExpire> | True or False. If ‘true’ the ticket will never |
| | time out. |
| | Only for use by users where it is impractical to |
| | send keep-alive messages. |
| | If not specified the default is ‘false’ |
| <clientInfo> | An optional freeform value which the client |
| | can use to indicate what it is and any other |
| | information which it is useful to be noted |
| | against the ticket. (e.g. “DeviceGraphNano - |
| | JobId 1234”) |
| <tags> | An optional list of tags which may be applied |
| | to the resource being created. Not currently |
| | used for database provisioning. |
| | Format is “key1 = value1, key2 = value2 etc.” |

Result of the API call may include, for example:
202, {“data”:{ticketed“:”<TicketId>“}}
POST http://qqq} HTTP/1.1

### User-Agent: Fiddler

Host: ab-resourcemanager-qa.cloudapp.net

### Content-Length:57

Content-type: application/json{“ReadCapacity”: 10, “WriteCapacity”: 1, “Priority”: 1, “ClientInfo”: “Hello world!”, “NoExpire”:true}
It is to be noted that “qqq” relates to a string of characters.

In an embodiment, for requesting a status of the ticket the API call may include:

### Method: GET

Route: api/v1/resource/<ResourceType>/{<TicketId>}
Table 3 illustrates meaning of the parameters used in the above API call for requesting a status of the ticket:

| Name | Meaning |
|---|---|
| <ResourceType> | The type of resource required (Maps |
| | internally to a database table) |
| | Possible values are: |
| | CookieSyncA2P |
| | CookieSyncP2A |
| <TicketId> | The ID of a ticket as previously |
| | obtained by the POST |

### Result:

When resource is not yet available:
200, {“data”:{“resourceStatus”:“NotAvailable”,“resourceHandle”:“ ”}}
When resource is available:
200,{“data”: {“resourceStatus”: “Available”,“resourceHandle”: “<ResourceP ath>”}}
where <ResourcePath> is a path to the underlying
When ticket has timed out:
403, {“message”:“Ticket ID 346ba356-6b46-4d21-adb4-ea6d3f5ee678 has expired.”}
It is to be appreciated that the client must not proceed with I/O against the resource until this call returns ‘Available’.
When the ticket was not found:
404, {“message”:“Ticket ID 346ba356-6b46-4d21-adb4-ea6d3f5ee678 not found.”}

### Example Fiddler Snippet:

GET http://xxx} HTTP/1.1

### User-Agent: Fiddler

Host: ab-resourcemanager-qa.cloudapp.net
It is to be noted that “xxx” relates to a string of characters.

In an embodiment, for keeping the ticket alive (preventing ticket timeout), the following API call is executed:

### Method: PUT

Route: api/v1/resource/<ResourceType>/{<TicketId>}
Table 4 illustrates meanings of the parameters used in the above API call for keeping the ticket alive:

| Name | Meaning |
|---|---|
| <ResourceType> | The type of resource required. (Maps |
| | internally to a database table.) Possible values |
| | are: |
| | CookieSyncA2P |
| | CookieSyncP2A |
| <TicketId> | The ID of a ticket as previously obtained by |
| | the POST |

In an embodiment, for notifying completion of the ticket, following API call is executed:

### Method: DELETE

Route: api/v1/resource/<ResourceType>/{<TicketId>}
Table 5 illustrates meaning of the parameters used in the API call for notifying completion of the ticket:

| Parameter Name | Meaning |
|---|---|
| <ResourceType> | The type of resource required. (Maps |
| | internally to a database table.) Possible values |
| | are: |
| | CookieSyncA2P |
| | CookieSyncP2A |
| <TicketId> | The ID of a ticket as previously obtained by |
| | the POST |

Result of the API call is following:
When the request was successful:
202
When the ticket Id was invalid:
404, {“message”:“Ticket ID<Ticketld> not found.”}
When the resource has not yet been allocated:
403, {“message”: “Resource for ticket with ID<TicketId> has not yet been allocated.”}
When the ticket has expired:
403, {“message”:“Ticket ID<Ticketld> has expired.”}
An example Fiddler snippet is as follows:
DELETE http://localhost: yyy} HTTP/1.1

### User-Agent: Fiddler

Host: ab-resourcennanager-qa.cloudapp.net
It is to be noted that “yyy” relates to a string of characters.

In an embodiment, the API call for pinging the API includes:

### Method: GET

Route: api/v1/resource

### Result: 200

An example of Fiddler snippet may include:

GET http://zzz} HTTP/1.1

### User-Agent: Fiddler

Host: ab-resourcennanager-qa.cloudapp.net
It is to be noted that “zzz” relates to a string of characters.

The disclosed computing system and method helps the users to manage the up-scaling and down-scaling of costly resources. The system and method are implemented at the API layer and not the infrastructure and server layer, hence it provides a much finer grained ability to manage resources such as, the servers, storage space in the cloud computing network.

The disclosed method and system give control of pricing back to the users that can be business entities or individuals. The system may allow the developers to have an atomic control of their elastic resources, with application cognizance, using a simple REST API, that affords the individuals the ability to have highly dynamic and absolute resources and costing control.

Various companies may use the disclosed methods and systems for managing their expenses and cost for elastic resources and services in the cloud-computing network.

While specific embodiments have been described in the disclosure, it will be appreciated that many modifications and changes may be made by those skilled in the art without departing from the scope of the disclosure. It is intended, therefore, by the appended claims to cover all such modifications.

In the foregoing, an expression “one or more” is to be construed to relate to the singular in a given example embodiment of the present disclosure, and to relate to the plural in another given example embodiment of the present disclosure. The phrase “at least one” is to be construed similarly, namely allowing for the plural as an option.

What is claimed is:

1. A computing system for providing cloud-computing services via a data communication network arrangement to one or more users, wherein the computing system includes:
a data server arrangement for providing the cloud-computing services, characterized in that the data server arrangement includes:
a tokenized accounting arrangement that is operable to control the data server arrangement for providing services to the one or more users; and
at least one application program interface (API) layer that is operable to manage and monitor user utilization of the data server arrangement via the tokenized accounting arrangement.

2. A computing system of claim 1, wherein the at least one application program interface (API) layer is operable to make one or more clusters of servers of the data server arrangement available for allocating one or more services for implementing a given task, and to redeploy servers of the one or more clusters to be available to other users at completion of the given task.

3. A computing system of claim 1, wherein the at least one application program interface (API) layer is operable to collate information from tokens of the tokenized accounting arrangement corresponding to cloud-computing services provided to the one or more users for predicting temporal changes and/or temporal patterns in utilization of the data server arrangement for use in controlling provision of data server capacity for the data server arrangement.

4. A computing system of claim 1, wherein the tokenized accounting arrangement is operable to receive ticket requests from the one or more users for cloud-computing services, and to make cloud-computing services available to a given user of the one or more users after receiving a plurality of ticket requests from the given user.

5. A computing system of claim 4, wherein the given user is operable to inform the at least one application program interface (API) layer that the user's ticket request is completed, for enabling the tokenized accounting arrangement to redeploy servers of the one or more clusters to process ticket requests of other users.

6. A method of operating a computing system for providing cloud-computing services via a data communication network arrangement to one or more users, characterized in that the method includes:
(i) arranging for the computing system to include a data server arrangement for providing the cloud-computing services;
(ii) arranging for the data server arrangement to include at least one application program interface (API) layer that is operable to manage and monitor user utilization of the data server arrangement via a tokenized accounting arrangement; and
(iii) using the tokenized accounting arrangement to control the server arrangement for providing services to the one or more users.

7. A method of claim 6, wherein the method includes operating the at least one application program interface (API) layer to make one or more clusters of servers of the data server arrangement available for allocated one or more users for implementing a given task, and to redeploy servers of the one or more clusters to be available to other users at completion of the given task.

8. A method of claim 6, wherein the method includes operating the at least one application program interface (API) layer to collate information from tokens of the tokenized accounting arrangement corresponding to cloud-computing services provided to the one or more users for predicting temporal changes and/or temporal patterns in utilization of the data server arrangement for use in controlling provision of data server capacity for the data server arrangement.

9. A method of claim 6, wherein the method includes operating the tokenized accounting arrangement to receive ticket requests from the one or more users for cloud-computing services, and to make cloud-computing services available to a given user of the one or more users after receiving a plurality of ticket requests from the given user.

10. A method of claim 9, wherein the method further comprises:
receiving, by the at least one application program interface (API) layer, an information from the given user that the user's ticket request is completed; and
redeploying, by the tokenized arrangement, servers of the one or more clusters to process ticket requests of other users based on the received information.

11. A non-transitory tangible computer readable medium comprising instructions for operating a computing system for providing cloud-computing services via a data communication network arrangement to one or more users, the non-transitory tangible computer readable medium comprising instructions for:
arranging for the computing system to include a data server arrangement for providing the cloud-computing services;
arranging for the data server arrangement to include at least one application program interface (API) layer that is operable to manage and monitor user utilization of the data server arrangement via a tokenized accounting arrangement; and
using the tokenized accounting arrangement to control the server arrangement for providing services to the one or more users.

12. A non-transitory tangible computer readable medium of claim 11, further comprising instructions for operating the at least one application program interface (API) layer to make one or more clusters of servers of the data server arrangement available for allocated one or more users for implementing a given task, and to redeploy servers of the one or more clusters to be available to other users at completion of the given task.

13. A non-transitory tangible computer readable medium of claim 11, further comprising instructions for operating the at least one application program interface (API) layer to collate information from tokens of the tokenized accounting arrangement corresponding to cloud-computing services provided to the one or more users for predicting temporal changes and/or temporal patterns in utilization of the data server arrangement for use in controlling provision of data server capacity for the data server arrangement.

14. A non-transitory tangible computer readable medium of claim 11, further comprising instructions for operating the tokenized accounting arrangement to receiver ticket requests from the one or more users for cloud-computing services, and to make cloud-computing services available to a given user of the one or more users after receiving a plurality of ticket requests from the given user.

15. A non-transitory tangible computer readable medium of claim 14 further comprising instructions for:
receiving an information from the given user that the user's ticket request is completed; and
redeploying servers of the one or more clusters to process ticket requests of other users based on the received information.
